(19) United States
(12) Patent Application Publication
(10) Pub. No.: US 2026/0356342 A1
(43) Pub. Date: Nov. 12, 2026

(54) System and Method for Testing Tractor Protection Functionality in a Combination Vehicle

(71) Applicant: KB Intellectual Property GmbH & Co. KG, Pullach (DE)

(72) Inventor: Christopher H. Hutchins, Bay Village, OH (US)

(21) Appl. No.: 19/204,671

(22) Filed: May 12, 2025

(51) Int. Cl. B60T 17/22; B60T 8/17; B60T 8/171

(52) U.S. Cl. CPC B60T 17/22; B60T 8/1708; B60T 8/171; B60T 2270/406

(57) ABSTRACT

A system and method for testing a fluid supply protection system in a brake control system in a combination vehicle includes a controller that determines whether various prerequisite conditions are met such as a source pressure in a fluid source on the towing member being above a threshold. If the conditions are met, the controller configures a valve module on the towing member to deliver fluid from the fluid source to the control conduit. The controller determines, responsive to a measurement signal indicative of a measured value of a characteristic of fluid in the control conduit, whether the measured value meets a predetermined condition relative to a threshold value and, if it does not, generates a failure signal used to communicate the results of the test and/or alter the operation of the brake control system.

### BACKGROUND OF THE INVENTION

### a. Field of the Invention

This disclosure relates to a system and method for testing a fluid supply protection system in a brake control system in a combination vehicle. In particular, this disclosure relates to a system and method that enable automated testing of the fluid supply protection system both prior to and during operation of the vehicle and that eliminate the need to rely on an assessment of the fluid supply protection system’s performance by the vehicle operator.

### b. Background Art

Conventional combination vehicles with fluid controlled braking systems transmit fluid from a towing member or power unit of the combination vehicle to a towed member of the combination vehicle along two different lines or conduits. One of the conduits, the supply conduit (commonly red in color), is used to transmit fluid from one or more fluid reservoirs on the towing member to (i) wheel brakes on the towed member for use in releasing parking brakes in the wheel brakes and (ii) fluid reservoirs on the towed member for use in applying service brakes in the wheel brakes or other fluid-controlled accessories on the towed member. The other conduit, the control conduit or service conduit (commonly blue in color), is used to transmit a fluid signal that causes application of the service brakes in the wheel brakes of the towed member in an amount proportional to the fluid signal.

In the event of a rupture in the control conduit between the towing member and towed member, or when the towing member is not coupled to any towed members (i.e., is operating in a bobtail configuration), any fluid transmitted through the control conduit will be exhausted to atmosphere. The loss of this fluid decreases available fluid pressure in the towing vehicle, leading to increased operation of fluid accumulation components (e.g., compressors, air treatment systems) and potential reductions in brake performance on the towing vehicle. For this reason, conventional combination vehicles include fluid supply protection systems that are intended to prevent discharge of fluid through the control conduit in these situations. For example, many conventional vehicles include a valve commonly referred to as a tractor protection valve that prevents transmission of fluid to the control conduit when fluid is not present in the supply conduit. Because of the important role that these fluid supply protection systems play in protecting the fluid supply of the towing member, it is important to know whether the systems are operating properly. Conventional methods for evaluating the operation of fluid supply protection systems, however, rely on the ability of an operator of the vehicle to identify when the system is operating improperly. For example, if system incorrectly prevents delivery of the fluid signal to actuate the service brakes on the towed member, the operator may notice an unanticipated decrease in braking force as compared to when the system is operating properly. Reliance on operator assessment of the performance of fluid supply protection systems is problematic. Because of the increased in automated brake control functions in modern combination vehicles, it is more difficult for the operator to identify improper performance of fluid supply protection systems. Further, newer vehicles are being configured to include automated driving systems in which the vehicle is controlled without the involvement of, or at least less involvement of, human operators.

The inventors herein have recognized a need for a system and method for testing a fluid supply protection system in a brake control system of a combination vehicle that will minimize and/or eliminate one or more of the above-identified deficiencies.

### BRIEF SUMMARY OF THE INVENTION

This disclosure relates to a system and method for testing a fluid supply protection system in a brake control system in a combination vehicle. In particular, this disclosure relates to a system and method that enable automated testing of the fluid supply protection system both prior to and during operation of the vehicle and that eliminate the need to rely on an assessment of the fluid supply protection system’s performance by the vehicle operator.

An embodiment of a system for conducting a test of a fluid supply protection system in a brake control system in a combination vehicle, the fluid supply protection system configured to prevent delivery of fluid to a control conduit that extends between a towing member of the combination vehicle and a towed member of the combination vehicle in the absence of a sealed fluid path from the towing member to the towed member through the control conduit, the control conduit configured to transmit a service brake control signal from the towing member to the towed member, includes a controller configured to determine whether one or more prerequisite conditions are met. One of the one or more prerequisite conditions comprises a source pressure in a fluid source on the towing member above a threshold source pressure. The controller is further configured to configure, if the one or more prerequisite conditions are met, a valve module on the towing member to deliver fluid from the fluid source to the control conduit. The controller is further configured to determine, responsive to a measurement signal indicative of a measured value of a characteristic of fluid in the control conduit, whether the measured value meets a predetermined condition relative to a threshold value and to generate a failure signal if the measured value does not meet the predetermined condition relative to the threshold value.

An embodiment of an article of manufacture includes a non-transitory computer storage medium having a computer program encoded thereon that, when executed by a controller, conducts a test of a fluid supply protection system in a brake control system in a combination vehicle, the fluid supply protection system configured to prevent delivery of fluid to a control conduit that extends between a towing member of the combination vehicle and a towed member of the combination vehicle in the absence of a sealed fluid path from the towing member to the towed member through the control conduit, the control conduit configured to transmit a service brake control signal from the towing member to the towed member. The computer program includes code for determining whether one or more prerequisite conditions are met. One of the one or more prerequisite conditions comprises a source pressure in a fluid source on the towing member above a threshold source pressure. The computer program further includes code for configuring, if the one or more prerequisite conditions are met, a valve module on the towing member to deliver fluid from the fluid source to the control conduit. The computer program further includes code for determining, responsive to a measurement signal indicative of a measured value of a characteristic of fluid in the control conduit, whether the measured value meets a predetermined condition relative to a threshold value and generating a failure signal if the measured value does not meet the predetermined condition relative to the threshold value.

An embodiment of a method for conducting a test of a fluid supply protection system in a brake control system in a combination vehicle, the fluid supply protection system configured to prevent delivery of fluid to a control conduit that extends between a towing member of the combination vehicle and a towed member of the combination vehicle in the absence of a sealed fluid path from the towing member to the towed member through the control conduit, the control conduit configured to transmit a service brake control signal from the towing member to the towed member, includes determining whether one or more prerequisite conditions are met. One of the one or more prerequisite conditions comprises a source pressure in a fluid source on the towing member above a threshold source pressure. The method further includes configuring, if the one or more prerequisite conditions are met, a valve module on the towing member to deliver fluid from the fluid source to the control conduit. The method further includes determining, responsive to a measurement signal indicative of a measured value of a characteristic of fluid in the control conduit, whether the measured value meets a predetermined condition relative to a threshold value and generating a failure signal if the measured value does not meet the first predetermined condition relative to the threshold value.

A system and method for testing a fluid supply protection system in a brake control system of a combination vehicle in accordance with the teachings disclosed herein is advantageous relative to conventional systems and methods. In particular, the system and method allow for testing multiple potential failure modes of the fluid supply protection system both before and during operation of the vehicle. Further, the system and method eliminate the need to rely on an assessment of the fluid supply protection system’s performance by the vehicle operator so that reliable information regarding the performance of the fluid supply protection system can be obtained in wider range of vehicles including those incorporating automated brake control functions as well as those including automated driving systems (ADS). Using this information, it is possible to predict degradation of brake performance due to (i) failure to active the fluid supply protection system when required leading to increased fluid consumption, fluid loss and a reduction in braking force and (ii) improper activation of the fluid supply protection system preventing activation of trailer service brakes.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a combination vehicle.

FIG. 2 is a diagrammatic view of a brake control system for the combination vehicle of FIG. 1 including a system for conducting a test of a fluid supply protection system of the brake control system in accordance with the teachings set forth herein.

FIGS. 3A-C are diagrammatic views of a portion of the brake control system of FIG. 2.

FIG. 4 is a flow chart diagram illustrating several steps in various embodiments of a method for conducting a test of the fluid supply protection system in accordance with the teachings set forth herein.

### DETAILED DESCRIPTION OF THE INVENTION

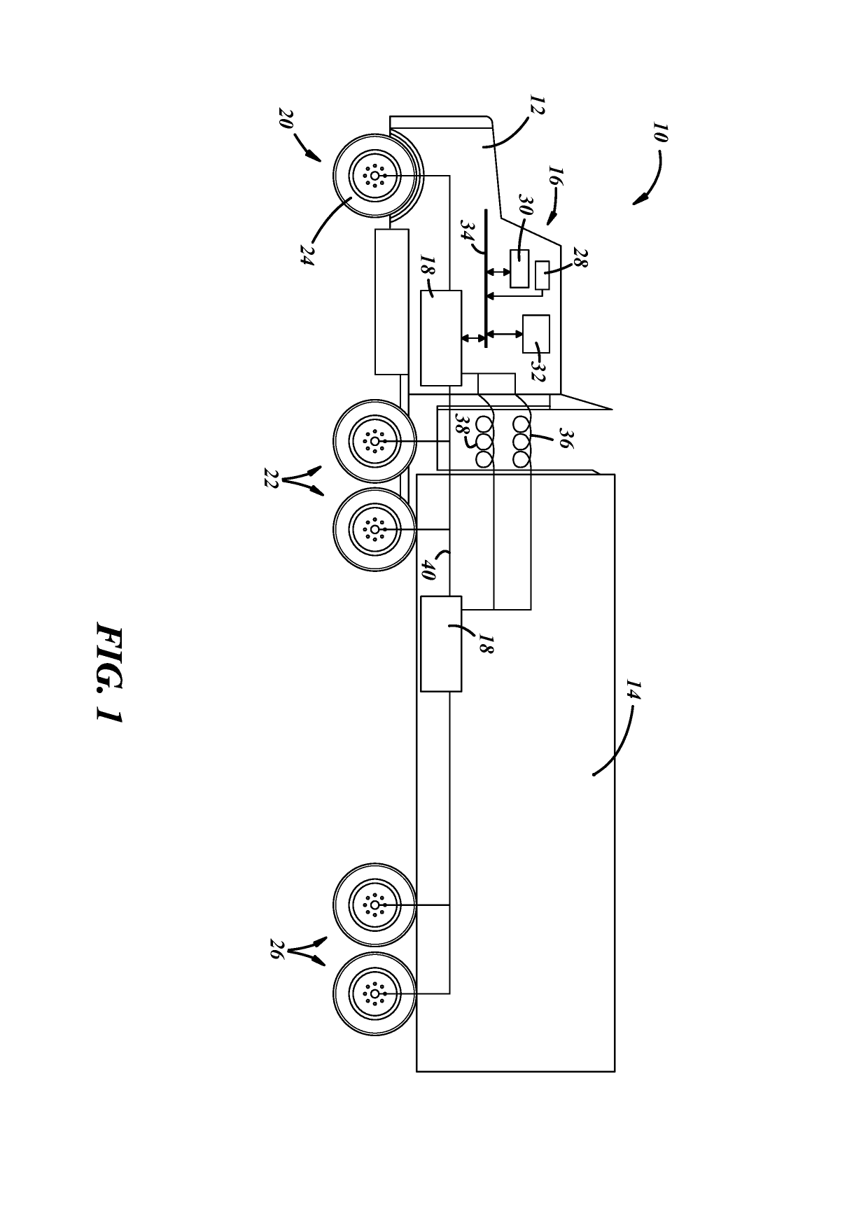

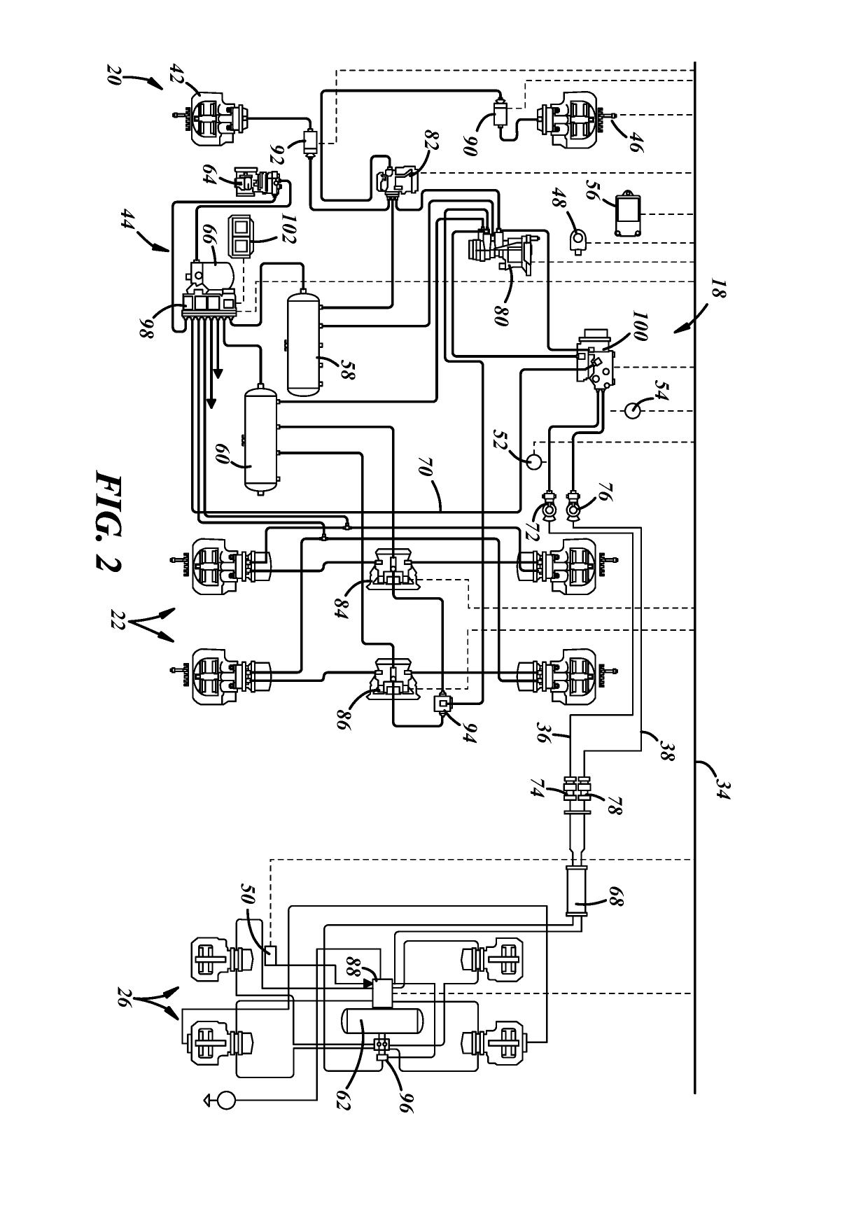

Referring now to the drawings wherein like reference numerals are used to identify identical components in the various views, FIG. 1 illustrates a combination vehicle 10. In the illustrated embodiment, vehicle 10 comprises a commercial vehicle and, in particular, a tractor-trailer. It should be understood, however, that the systems and methods disclosed herein may find application on other types of commercial and non-commercial combination vehicles. Vehicle 10 includes a towing member 12 (e.g., a tractor) and one or more towed members 14 (e.g., a semi-trailer). Vehicle 10 may include one or more advanced driver assistance systems (ADAS) or automated driving systems (AD) 16 (hereinafter, an “ADAS/AD system”) and includes a brake control system 18 for slowing, stopping and/or preventing movement of vehicle 10.

Towing member 12 provides power for moving towed member 14. Towing member 12 includes steering and drive axles 20, 22 each of which support one or more wheels 24 at either end. Towing member 12 further includes a power unit, such as an internal combustion engine or electric motor for generating mechanical energy used to rotate the wheels and a battery that provides electrical energy for use in starting the power unit and, in embodiments where the power unit includes an electric motor, for use by the power unit in generating the mechanical energy used to drive the wheels. The battery may also provide power to various accessory systems on vehicle 10.

Towed member 14 is detachably coupled to towing member 12. In the illustrated embodiment, towed member 14 comprises a semi-trailer configured to carry or store freight, but it should be understood that towed member 14 may assume other forms including, for example, a full trailer or dolly. Further, although a single towed member 14 is shown in the illustrated embodiment, it should be understood that the number of towed members attached to towing member 12 may vary. Towed member 14 is supported on one or more trailer axles 26, each of which may support one or more wheels 24 at either end.

ADAS/AD systems 16 are provided to assist the operator of vehicle 10 by providing information (e.g., warnings) to the operator and/or assuming control of, or supplementing operator control of, various vehicle systems. ADAS/AD systems 16 may, for example, include forward collision warning systems, blind-spot warning systems, lane departure warning systems, cross traffic warning systems, automated emergency braking (AEB) systems, anti-lock braking (ABS) systems, collision avoidance systems, adaptive cruise control systems, traction control systems, stability control systems, lane keep assist systems or lane centering systems and parking assist systems. An ADAS/AD system 16 may include one or more sensors 28, an operator interface 30 and a controller 32. Sensors 28, operator interface 30 and controller 32 may communicate with one another through direct electrical connections or over a conventional vehicle communications bus 34 implementing a communications network such as a controller area network (CAN) or local interconnect network (LIN) or over a vehicle power line through power line communication (PLC) in accordance with various industry standard protocols including but not limited to SAE J1939, SAEJ1922, and SAE J2497 or using a proprietary protocol.

Sensors 28 are provided to identify various conditions associated with vehicle 10 and the surrounding environment including conditions that may impact the operation of vehicle 10. Sensors 28 may, for example, include speed sensors configured to determine the rotational speed of a component of vehicle 10 such as a wheel (i.e., a wheel speed sensor) or a power transmission shaft. Sensors 28 may include pressure sensors configured to determine atmospheric pressure or the pressure in a component of vehicle 10 such as tire, a brake actuator chamber, a compressor, or a conduit of a fluid circuit that delivers fluid to, or exhausts fluid from, another component of vehicle 10. Sensors 28 may include position sensors configured to determine a degree of rotation of a component of vehicle 10 such as a steering column component indicative of the steer angle for vehicle 10 (i.e., a steer angle sensor) or to determine the state or position of a component of vehicle 10 such as a brake pedal or door. Sensors 28 may include temperature sensors configured to determine ambient temperature in the area in which vehicle 10 is located or a localized temperature within vehicle 10. Sensors 28 may include moisture sensors configured to determine humidity. Sensors 28 may include altimeters configured to determine the altitude of vehicle 10 or the change in grade of the surface on which vehicle 10 is travelling. Sensors 28 may include GPS sensors or yaw rate sensors configured to determine the direction of travel of vehicle 10. Sensors 28 may also include voltage or current sensors configured to measure the voltage or current level in component of vehicle 10. Sensors 28 may also include radar (radio detection and ranging) sensors, lidar (light detection and ranging) sensors, or cameras configured to output signals indicative of the presence of objects (e.g., other vehicles, pedestrians or road infrastructure) within a defined field of view and to provide information regarding the objects including, for example, the position or location of the object within the field of view and the distance between the object and vehicle 10. It should be understood that this listing of types of sensors 28 and the operating conditions measured or sensed by the sensors 28 is not meant to be exhaustive and that other types of sensors 28 could be employed for use within an ADAS/AD system 16.

Operator interface 30 provides an interface between the vehicle operator and ADAS/AD system 16 through which the operator can control certain vehicle functions and receive information about the operation of vehicle 10. Interface 30 may be mounted within the cabin of vehicle 10 and, in particular, on the dashboard of vehicle 10. Interface 30 may assume various forms. Interface 30 may, for example, include a touch screen display with a graphical user interface (GUI). Interface 30 may include one or more handles, push buttons or switches through which an operator may input commands to vehicle 10. Interface 30 may also include light emitters, such as light emitting diodes, sound emitters, such as a speaker, and/or haptic actuators to output visual, audio and/or haptic messages (e.g., warnings or alerts) to the vehicle operator. In the case of visual messages, different information can be conveyed through differences in color, differences in intensity, differences in the number of lights, and differences in the pattern of activation of the lights. In the case of audio messages, different information can be conveyed through differences in the type of sound generated, differences in volume and differences in the pattern of sounds. In the case of haptic messages, different information can be conveyed through differences in the length, intensity, or pattern of vibration.

Controller 32 determines whether warnings and/or assistance to the operator of vehicle 10 are required and, when required, generates control signals to provide the warnings and/or assistance. Controller 32 may comprise a programmable microprocessor or microcontroller or may comprise application specific integrated circuits (ASIC). Controller 32 may include a memory and a central processing unit (CPU). Controller 32 may also include an input/output (I/O) interface including a plurality of input/output pins or terminals through which the controller 32 may receive a plurality of input signals and transmit a plurality of output signals. The controller 32 may, for example, receive input signals from sensors 28, operator interface 30, and other systems on vehicle 10 such as brake control system 18. Controller 32 may, for example, transmit output signals to operator interface 30 or other control systems on vehicle 10 including, for example, brake request signals to brake control system 18. In accordance with certain embodiments of the systems and methods disclosed herein, controllers 32 for one or more ADAS/AD systems 16 may also be configured to transmit requests to brake control system 18 to conduct a test of a fluid supply protection system within brake control system 18.

Brake control system 18 is provided to brake wheels 24 on towing member 12 and towed member 14 to slow, stop or prevent movement of vehicle 10. System 18 may include components on both towing member 12 and towed member 14 that may be in fluid and/or electrical communication using conventional fluid hoses or conduits 36, 38 and electrical conductors 40 extending between towing member 12 and towed member 14. Conduit 36, referred to herein as supply conduit 36 and typically red in color, and conduit 38, referred to herein as service conduit 38 and typically blue in color, enable delivery of fluid pressure and fluid control signals, respectively, from towing member 12 to towed member 14 for use in applying and releasing wheel brakes associated with the wheels 24 on trailer axles 26. As discussed in greater detail below, brake control system 18 includes a fluid supply protection system intended to prevent the loss of fluid from fluid sources on towing member 12 through conduits 36, 38 when, for example, a towed member 14 is not coupled to towing member 12 or a rupture has occurred in conduits 36, 38. Electrical conductors 40 allow for the exchange of messages (data or commands)—including the electronic control signals discussed below—between components of brake control system 18 on towing member 12 and towed member 14. Conductors 40 may, for example, form a portion of vehicle communications bus 34 or a portion of a vehicle power line. Referring now to FIG. 2, brake control system 18 may include wheel brakes 42, a fluid circuit 44 that supplies fluid pressure to wheel brakes 42, sensors 46, 48, 50, 52, 54 that identify various conditions associated with vehicle 10 and the surrounding environment that impact braking of vehicle 10 and one or more controllers 56.

Wheel brakes 42 are configured to apply a braking force to one or more wheels 24 on vehicle 10. Wheel brakes 42 are located at each end of steer axle 20, drive axles 22 and trailer axles 26. In the illustrated embodiment, wheel brakes 42 comprise disc brakes in which a carrier supports brake pads on opposite sides of a rotor rotating with the wheel 24 and an actuator causes, responsive to fluid pressure delivered by fluid circuit 44, movement of a caliper relative to the carrier to move the brake pads into and out of engagement with the rotor. Alternatively, one or more of wheel brakes 42 may comprise drum brakes in which an actuator such as a cam or piston causes, responsive to fluid pressure delivered by fluid circuit 44, movement of one or more brake shoes into engagement with a braking surface in a brake drum rotating with wheel 24. Wheel brakes 42 may be configured to function as both a service brake for applying service braking while the vehicle is an active state and as a parking brake for applying parking or emergency braking while the vehicle is an active or inactive state. To enable functionality as a service brake, the brake actuator for wheel brake 42 may include a member (e.g., a pushrod connected to a diaphragm) that is moved in one direction responsive to the presence of fluid pressure to move the wheel brake 42 to an applied state and in the opposite direction responsive to the absence of fluid pressure to move the wheel brake 42 to a released state. To enable functionality as a parking brake, the brake actuator for wheel brake 42 may include a spring that biases the wheel brake 42 to an applied state. Fluid pressure provided to the brake actuator is used to overcome the force of the spring and move the wheel brake 42 to a released state.

Fluid circuit 44 generates fluid pressure within brake control system 18 and controls the delivery of fluid pressure to the actuator of each wheel brake 42 to apply or release either or both of a service brake and a parking brake depending on the configuration of the wheel brake 42. Circuit 44 may include components for generating and storing pressurized fluid including fluid sources 58, 60, 62, a compressor 64, and air treatment modules 66, 68 and components for routing and delivering fluid pressure to wheel brakes 42 including fluid conduits 70 and glad-hand connectors 72, 74, 76, 78, and various valve and valve modules for controlling the flow of fluid within circuit 44 including a foot brake valve module 80, relay valve modules 82, 84, 86, 88, modulator valves 90, 92, a quick release valve 94, a trailer parking control valve 96, a parking brake valve module 98, and a trailer pressure control valve module 100.

Fluid sources 58, 60, 62 store compressed fluid for use in applying or releasing wheel brakes 42. Fluid sources 58, 60 supply pressurized fluid to the wheel brakes 42 for steer axle 20 and drive axles 22. Fluid source 58 has fluid ports coupled to foot brake valve module 80, relay valve module 82 and parking brake valve module 98. Fluid source 60 has fluid ports coupled to foot brake valve module 80, relay valve modules 82, 84, and parking brake valve module 98. Fluid source 62 supplies pressurized fluid to the wheel brakes 42 for trailer axles 26. Fluid source 62 has fluid ports coupled to relay valve module 88 and trailer parking control valve 96.

Compressor 64 draws in air and compresses the air for delivery to fluid sources 58, 60 through air treatment module 66. Compressor 64 has one or more fluid ports coupled to air treatment module 66 and to parking brake valve module 98.

Air treatment modules 66, 68 are provided to collect and remove solid, liquid and vapor contaminants from pressurized fluid. Air treatment module 66 is disposed between compressor 64 and fluid sources 58, 60 and has fluid ports coupled to compressor 64 and parking brake valve module 98. Air treatment module 68 is supported on towed member 14 between glad-hand connectors 74, 78 and relay valve module 88 and has fluid ports coupled to glad-hand connectors 74, 78 and relay valve module 88. Air treatment module 68 assists in removing contaminants from the fluid in situations where towing member 12 lacks an air treatment module and/or when towed member 14 becomes disconnected from towing member 12.

Fluid conduits 70 are used to transport fluid between fluid sources 58, 60, 62 compressor 64, air treatment modules 66, 68, glad-hand connectors 72, 74, 76, 78, foot brake valve module 80, relay valve modules 82, 84, 86, 88, modulator valves 90, 92, quick release valve 94, trailer parking control valve 96, parking brake valve module 98, trailer pressure control valve module 100 and wheel brakes 42. Conduits 70 may be made from conventional metals and/or plastics and have connectors at either end configured to join the conduits 70 to corresponding components of fluid circuit 44.

Glad-hand connectors 72, 74 and 76, 78, are used to connect supply and control conduits 36, 38, respectively, to towing member 12 and towed member 14. Supply pressure travels from towing member 12 to towed member 14 through connector 72, supply conduit 36, and connector 74 for use in charging fluid source 62 and releasing parking brakes in the wheel brakes 42 for trailer axles 26. Fluid control signals. or service brake control signals, travel from towing member 12 to towed member 14 through connector 76, control conduit 38, and connector 78 to control application of fluid pressure during application of the service brakes in the wheel brakes 42 for trailer axles 26.

Foot brake valve module 80 provides an interface through which a vehicle operator may input a command to apply wheel brakes 42 and control the delivery of fluid pressure to wheel brakes 42 for service braking. Foot brake valve module 80 is supported within the cabin of towing member 12 and includes a brake pedal that may be actuated by the operator. Actuation of the brake pedal opens a valving member in foot brake valve module 80 that allows fluid pressure from fluid sources 58, 60 to flow to relay valve modules 82, 84, 86 and trailer pressure control valve module 100. Foot brake valve module 80 therefore has fluid ports in communication with fluid sources 58, 60, relay valve modules 82, 84, 86 and trailer pressure control valve module 100. It should be understood that foot brake valve module 80 represents one example of an operator-controlled valve module for service braking, but that other types of operator-controlled valves and valve modules for service braking may be used in addition to, or as an alternative to, foot brake valve module 80.

Relay valve modules 82, 84, 86, 88 are provided to control delivery of fluid pressure to wheel brakes 42 on steer axle 20, drive axles 22 and trailer axles 26, respectively, for use in controlling the application and release of service brakes in wheel brakes 42. Module 82 may define a single fluid channel configured to deliver the same fluid pressure to wheel brakes 42 on either end of steer axle 20. Modules 84, 86, 88 may define a pair of fluid channels permitting delivery of varying fluid pressure to the wheel brakes 42 on either end of drive axles 22 and trailer axles 26 for use in stability control. Modules 82, 84, 86, 88 include one or more relay valves that deliver fluid pressure from a fluid source 58, 60, 62 to wheel brakes 42 or exhaust fluid pressure from wheel brakes 42 responsive to a control pressure (from, for example, foot brake valve module 80 or trailer pressure control valve module 100). The relay valves increase the volume of fluid, and therefore the flow, at which fluid is delivered to, and exhausted from, wheel brakes 42 in order to reduce lag times between the commanded and actual application and release of wheel brakes 42. Modules 82, 84, 86, 88 further include solenoid valves configured to regulate the control pressure from the appropriate one of foot brake valve module 80 or trailer pressure control valve module 100 and, therefore, control the operation of the relay valve. An electronic control unit in each module 82, 84, 86, 88 controls the operation of the solenoid valves responsive to control signals from controller 56. The electronic control unit may also process signals from pressure sensors within modules 82, 84, 86, 88 and from wheel speed sensors 46 and brake lining wear sensors associated with corresponding wheels 24 and wheel brakes 42, respectively, and may generate and transmit signals indicative of fluid pressure, wheel speed and brake lining wear to controller 56. Modules 82, 84, 86, 88 may transmit signals to and/or receive signals from controller 56 indirectly over bus 34 or, alternatively, through dedicated electrical connections with controller 56. Relay valve module 82 has a fluid supply port in communication with fluid source 58, fluid delivery ports in fluid communication with modulator valves 90, 92 through which module 82 delivers fluid pressure for use in actuating wheel brakes 42 on steer axle 20, and a fluid control port in fluid communication with foot brake valve module 80. Relay valve modules 84, 86 each have a fluid supply port in communication with fluid source 60, fluid delivery ports in communication with the actuators for wheel brakes 42 on the end of a corresponding drive axle 22, and a fluid control port in communication with quick release valve 94. Relay valve module valve 88 has a fluid supply port in communication with fluid source 62, fluid delivery ports in communication with the brake actuators for wheel brakes 42 at the ends of each trailer axle 26, and a fluid control port in communication with air treatment module 68, and through module 68, control conduit 38. Relay valve modules 82, 84, 86, 88 may operate under the control of controller 56 to implement anti-lock braking/traction control when required.

Modulator valves 90, 92 are provided to implement an anti-lock braking function. During normal braking, valves 90, 92 allow fluid pressure to pass from relay valve module 82 to wheel brakes 42 on steer axle 20 without interference. During a loss of traction, however, signals from controller 56 causes modulator valves 90, 92 to modulate the fluid pressure to prevent lockup of the wheels 24. Modulator valves 90, 92 have fluid ports coupled to relay valve module 82 and to wheel brakes 42 on steer axle 20. Although the illustrated embodiment only includes modulator valves on steer axle 20, it should be understood that similar modulator valves may also be used on drive axles 22 and trailer axles 26. It should also be understood that modulator valves may be integrated with relay valve modules 82, 84, 86, 88.

Quick release valve 94 is provided to control the supply and exhaustion of fluid from the service brake chambers of the brake actuators for wheel brakes 42 on drive axles 22 responsive to actuation of food brake valve module 80. Valve 94 has a supply port in fluid communication with a delivery port on foot brake valve module 80 and delivery ports in fluid communication with control ports on relay valve modules 84, 86.

Trailer parking control valve 96 is provided to control the parking or emergency braking function of the actuators for the wheel brakes 42 on trailer axles 26 of semi-trailer 14. Valve 96 is coupled directly to fluid source 62. Valve 96 has fluid ports in communication with fluid source 62, air treatment module 68 and wheel brakes 42 on trailer axles 26.

Parking brake valve module 98 is provided to control delivery of fluid pressure to wheel brakes 42 on drive axles 22 and trailer axles 26, respectively, for use in controlling the application and release of parking brakes in wheel brakes 42. In one embodiment, parking brake valve module 98 is assembled together with air treatment module 66 as a single unit. Module 98 includes one or more relay valves that deliver fluid pressure from fluid sources 58, 60 to wheel brakes 42 on drive axles 22 and to supply conduit 36 (through trailer pressure control valve module 100) and that exhaust fluid pressure from wheel brakes 42 on drive axles 22 and supply conduit 36 responsive to a control pressure. The relay valves increase the volume of fluid, and therefore the flow, at which fluid is delivered to, and exhausted from, wheel brakes 42 and supply conduit 36 in order to reduce lag times between the commanded and actual application and release of the parking brakes in wheel brakes 42. Module 98 further include solenoid valves configured to regulate the control pressure and, therefore, control the operation of the relay valve responsive to electrical control signals from controller 56 or another control system such as an operator interface 102 in tractor 12. An electronic control unit in module 98 controls the operation of the solenoid valves responsive to the control signals from controller 56 or interface 102. The electronic control unit may also process signals from various sensors. Module 98 may transmit signals to and/or receive signals from controller 56 and/or interface 102 indirectly over bus 34 or, alternatively, through dedicated electrical connections with controller 56 and interface 102. Module 98 has fluid ports in communication with fluid sources 56, 58, compressor 64, wheel brakes 42 on drive axles 22, and trailer pressure control valve module 100.

Trailer pressure control valve module 100 is provided to control delivery of fluid pressure to wheel brakes 42 on trailer axles 26 for use in controlling the application and release of wheel brakes 42 on trailer axles 26. Module 100 has a fluid supply port in fluid communication with parking brake valve module 98, fluid delivery ports in fluid communication with supply and control conduits 36, 38 through gladhand connectors 72, 74 and 76, 78, respectively, and control ports in fluid communication with foot brake valve module 80. Module 100 delivers fluid pressure from parking brake valve module 98 to supply conduit 36 through gladhand connector 72. Module 98 is further configured to transmit a pneumatic service brake control signal to control conduit 38 through gladhand connector 76. Generation of the service brake control signal is controlled by a double check valve, a relay valve, and a plurality of solenoid valves in module 100. The double check valve outputs the higher fluid pressure received from foot brake valve module 80. The relay valve includes a supply port that receives the fluid pressure from parking brake valve module, a delivery port that outputs the service brake control signal and a control port. The characteristics of the service brake control signal are determined by a fluid control signal received at the control port of the relay valve. The fluid control signal may be obtained from the output of the double check valve as a result of actuation of the foot brake valve module 80 by the operator. Alternatively, the fluid control signal may be obtained through control of the solenoid valves to direct fluid pressure received from parking brake valve module 98 to the control port of the relay valve. The solenoid valves may be configured to direct fluid pressure from parking brake valve module 98 to the control port of the relay valve by, for example, electronic signals received from foot brake valve module 80 responsive to actuation of the foot brake valve module 80 by the operator. Alternatively, one or more systems on vehicle 10 (e.g., an ADAS/AD system 16) or controller 56 may request application of the service brakes even when not commanded by the operator of vehicle 10. The solenoid valves may further be controlled to implement a fluid supply protection system (often referred to as a tractor protection system) that prevents delivery of fluid to control conduit 38 in the absence of a sealed fluid path from towing member 12 to towed member 14 through control conduit 38 such as when a towed member 14 is not coupled to towing member 12 or there has been a rupture in control conduit 38. When these situations are detected by controller 56, controller 56 generates and transmits electronic signals to the solenoid valves to prevent delivery of the output of the double check valve to the control port of the relay valve. As a result, the relay valve in module 100 will not output any fluid pressure to control conduit 38 despite actuation of foot brake valve module 80 by the operator or an ADAS/AD system 16 thereby preventing the loss of fluid pressure from fluid sources 58, 60 to atmosphere through control conduit 38. Although the fluid supply protection system is implemented in valve module 100 in the illustrated embodiment, it should be understood the location of the fluid supply protection system will vary depending on the configuration of braking control system. For example, many conventional vehicles may have a dedicated tractor protection valve module located downstream of the trailer pressure control valve module 100 that provides the fluid supply protection system. Conventional tractor protection valve modules are configured to prevent delivery of fluid pressure to the control conduit 38 in the absence of fluid pressure in the supply conduit 36.

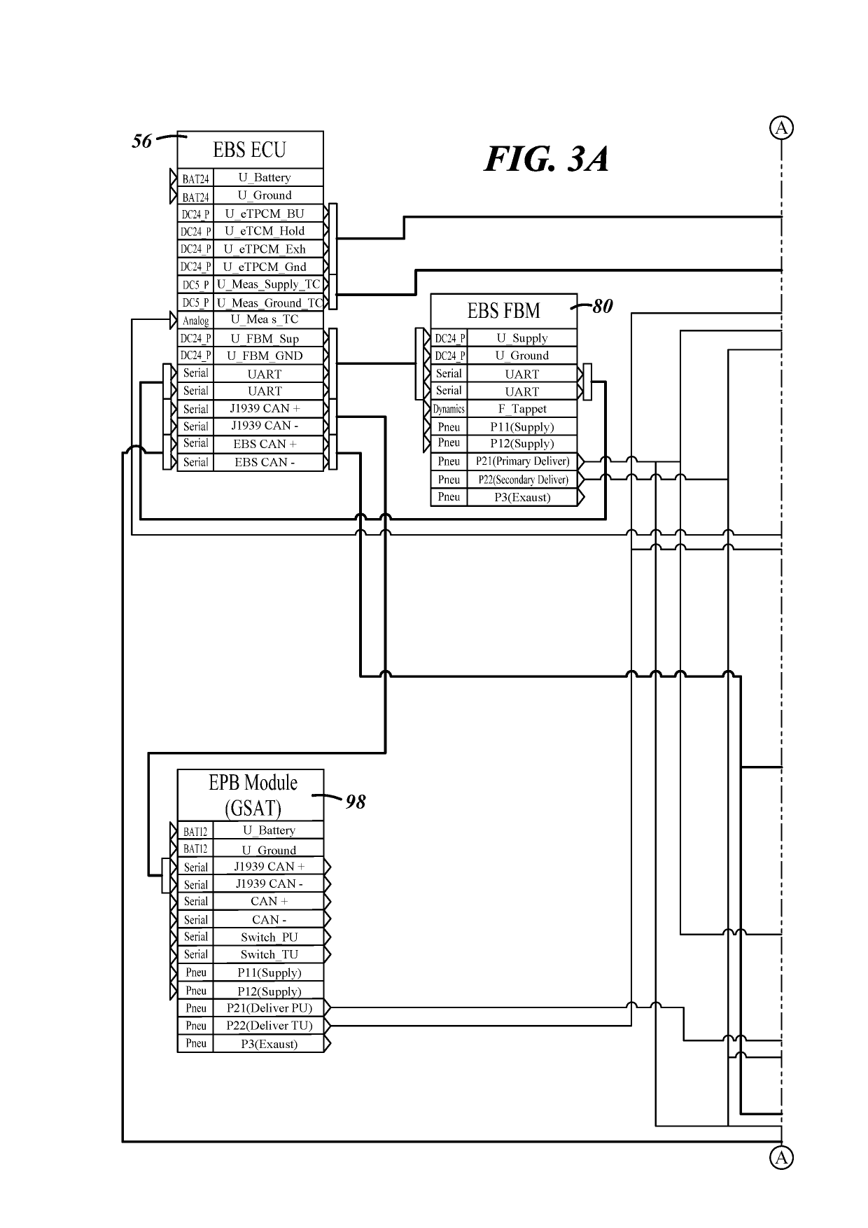

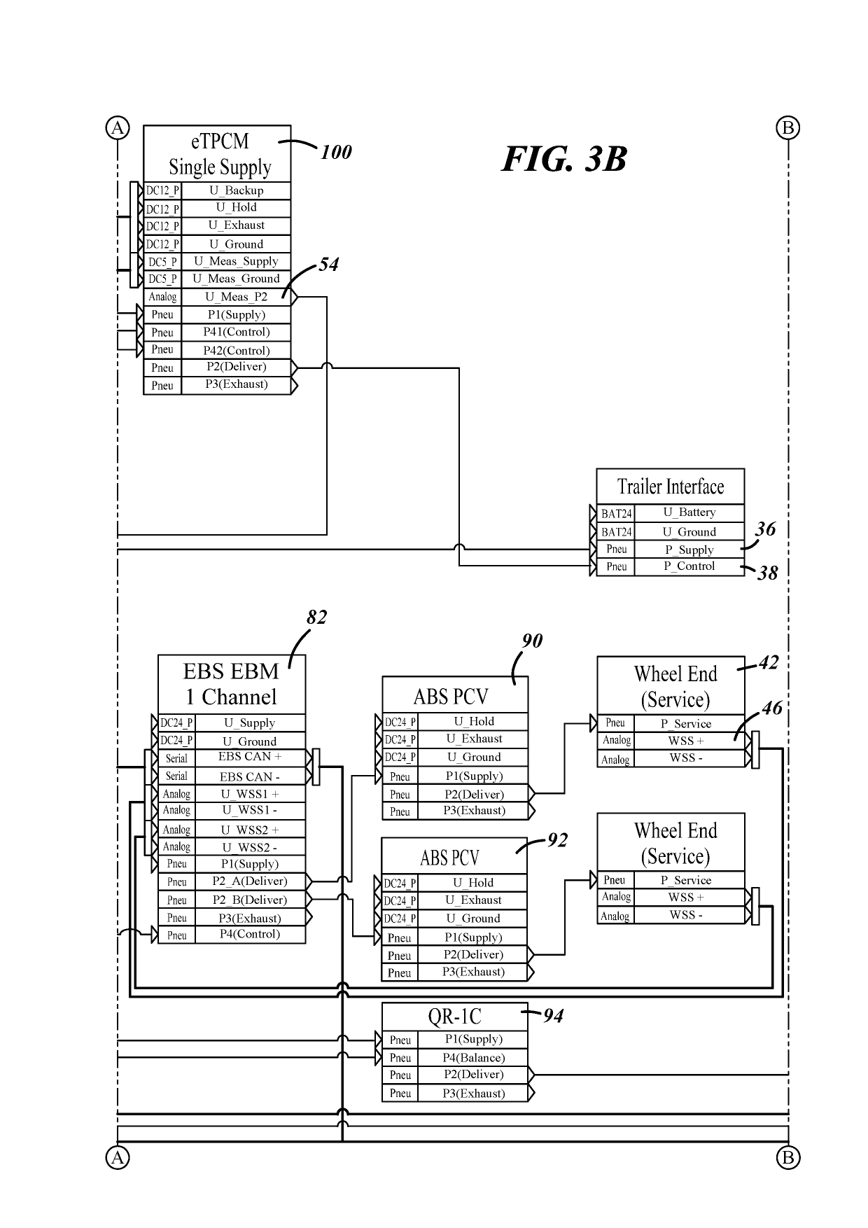

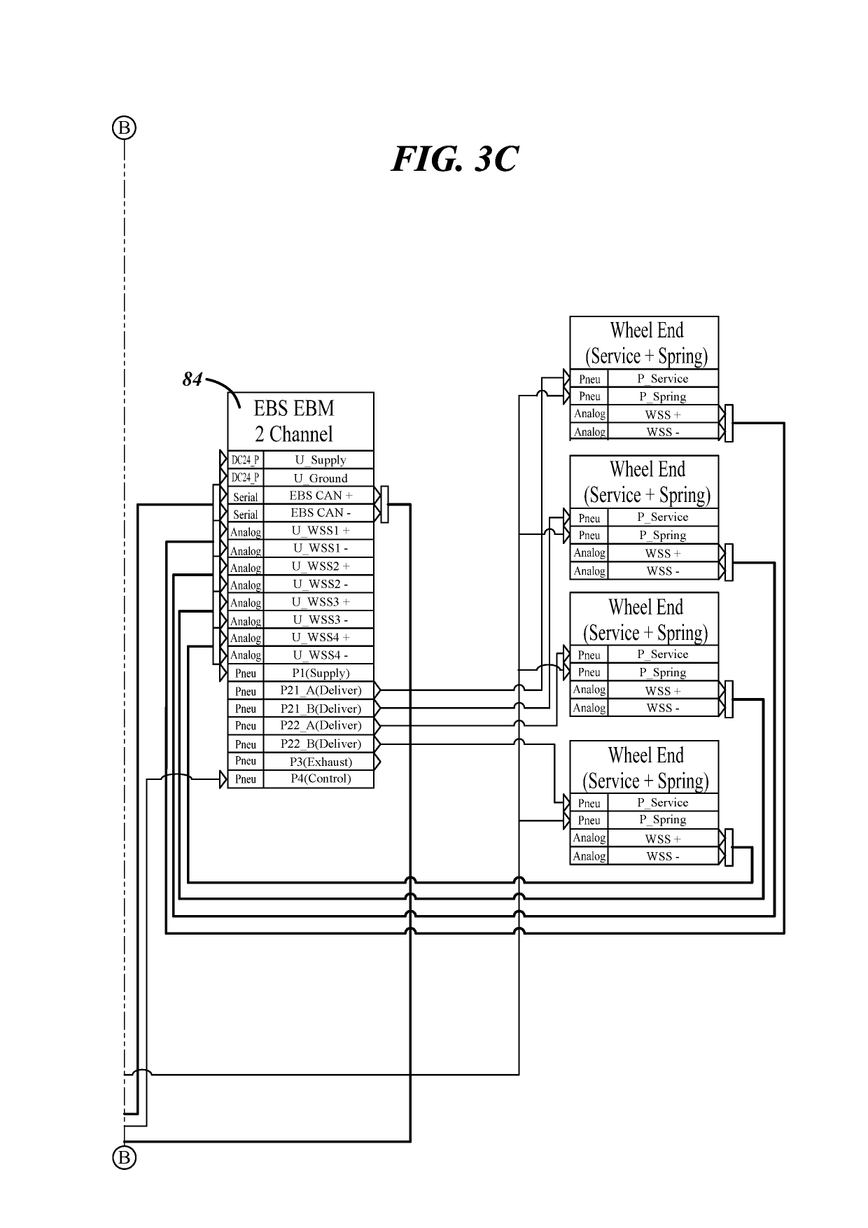

Sensors 46, 48, 50, 52, 54 identify various conditions associated with vehicle 10 and the surrounding environment that impact braking of vehicle 10. Wheel speed sensors 46 generate signals indicative of the rotational speed of a corresponding wheel 24. Each sensor 46 may include a magnet surrounded by a coil disposed proximate to a toothed ring on a wheel 24. Rotation of the toothed ring causes changes in the direction and intensity of the magnetic fields and is indicative of rotation of the wheel 24. Controller 56 can determine the rotational speed of each wheel 24 responsive to signals generated by sensors 46. Based on the rotational speed of wheels 24, controller 56 can determine whether certain wheels 24 are slipping and implement anti-lock braking through control of relay valve modules 82, 84, 86, 88 and modulators 90, 92. Controller 56 can also determine the speed of vehicle 10 responsive to the determined speed of wheels 24. Steer angle sensor 48 outputs a signal indicative of a steering angle imparted by a vehicle operator to a steering wheel in tractor 12. Sensor 48 may be mounted on a steering column within tractor 12. Load sensor 50 generates a signal indicative of the forces at a given location. Load sensor 50 may be used to determine the load on one or more of trailer axles 26 in order to assist in determining the stability of towed member 14. Load sensor 50 may comprise a strain gauge, piezoelectric sensor or a fluid (hydraulic or pneumatic) sensor. Sensors 52, 54 generate measurement signals indicative of the value of a characteristic of fluid at various locations within fluid circuit 44. Sensors 52, 54 may comprise pressure sensors configured to measure fluid pressure at locations within fluid circuit 44 or flow sensors configured to measure fluid flow at locations within fluid circuit 44. In the illustrated embodiment, sensors 52, 54 are used to measure fluid pressure and/or fluid flow in supply and control conduits 36, 38. Although sensors 52, 54 are illustrated in particular locations in the illustrated embodiment, it should be understood that sensors 52, 54 may be disposed in various locations. For example, sensors 52, 54 may be disposed within trailer pressure control valve module 100. Although only two sensors 52, 54 are illustrated in FIGS. 2 and 3A-C, it should be understood that additional sensors may be located throughout fluid circuit 44. Although certain types of sensors are shown in the illustrated embodiment, it should be understood that other embodiments may include additional sensors including, for example, engine or transmission speed sensors that generate signals indicate of the speed of vehicle 10 and yaw rate sensors.

Controller 56 controls the operation of various valve and valve modules in fluid circuit 44 in order to control the fluid pressure delivered to wheel brakes 42 and, therefore, the braking force applied to wheels 24. Controller 56 may comprise a programmable microprocessor or microcontroller or may comprise an application specific integrated circuit (ASIC). Controller 56 may include a memory and a central processing unit (CPU). Controller 56 may also include an input/output (I/O) interface including a plurality of input/output pins or terminals through which the controller 56 may receive a plurality of input signals and transmit a plurality of output signals. The input signals may include signals received from controller 32 in ADAS/AD system 16 and from sensors 46, 48, 50, 52, 54. The output signals may include signals used to control valves and valve modules in fluid circuit 44. Although a single controller 56 is shown in the illustrated embodiment, it should be understood that the functionality of controller 56 could be divided among multiple controllers including, for example, separate controllers on towing member 12 and towed member 14.

As noted above trailer pressure control valve module 100 may include a fluid supply protection system (or tractor protection system) that prevents delivery of fluid to control conduit 38 in the absence of a sealed fluid path from towing member 12 to towed member 14 through control conduit 38 (e.g. when a towed member 14 is not coupled to towing member 12 or there has been a rupture in control conduit 38), in order to prevent loss of fluid pressure from fluid sources 56, 58 when an operator or ADAS/AD system 16 attempts to apply the service brakes. In accordance with the present teachings, controller 56 may be configured with appropriate programming instructions (i.e., software or a computer program) to implement several steps in a method for conducting a test of the fluid supply protection system as described below. The instructions or computer program may be encoded on a non-transitory computer storage medium such as a memory within, or accessible by, controller 56. Although the following description contemplates that controller 56 executes the programming instructions, it should be understood that the programming instructions could alternatively be executed by a different controller (e.g., the electronic control unit in parking brake module 98) or by multiple controllers.

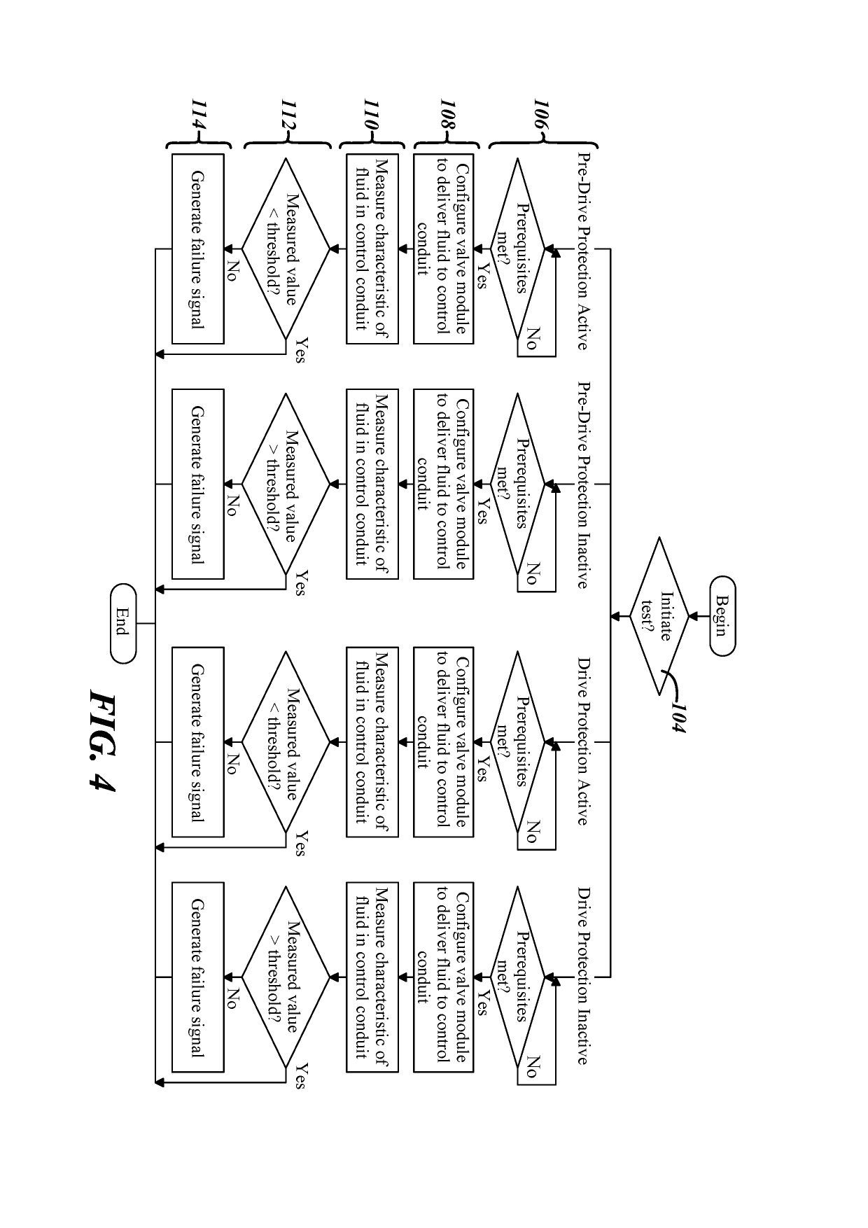

Referring now to FIG. 4, the method may begin with the step 104 of receiving a test initiation signal. In some embodiments, the test initiation signal may be an explicit request to conduct a test of the fluid supply protection system in brake control system 18 by another system on vehicle 10 such as ADAS/AD system 16. For example, controller 32 of ADAS/AD system 16 may generate and transmit a test initiation signal to controller 56 requesting that controller 56 initiate the test before ADAS/AD system 16 generates a brake request signal in order to ensure that brake control system 18 will function properly in response to the brake request signal. In other embodiments, the test initiation signal may comprise a signal indicative of one or more predetermined conditions that will cause controller 56 to initiate the test. For example, a disconnection of the towed member 14 from the towing member 12 or a rupture in supply conduit 36 or control conduit 38 may be sensed by one or more sensors (e.g., proximity sensors, load sensors, pressure sensors) and result in generation of signals indicative of the disconnection or rupture. These signals may act as test initiation signals that cause controller 56 to initiate the test. A request by an operator to apply the service brakes will result in changes within fluid circuit 44 that will be detected by various sensors. Position sensors may, for example, generate signals indicative of a change in position of a foot pedal or other operator interface. Pressure sensors may generate signals indicative of a change in fluid pressure in supply conduit 36 or another part of fluid circuit 44. These signals may also act as test initiation signals that cause controller 56 to initiate the test. Similarly, a request by an ADAS/AD system 16 to apply the service brakes may itself act as a test initiation signal and/or again result in changes within fluid circuit 44 that will be detected by various sensors and result in signals that act as a test initiation signal. Although controller 56 may conduct the test in response to a test initiation signal in certain embodiments, controller 56 may, in other embodiments, conduct the test without receiving a test initiation signal. Controller 56 may, for example, be configured to automatically conduct the test based on a predetermined schedule.

Once controller 56 determines that a test should be conducted (e.g., in response to a test initiation signal or based on a predetermined schedule), the method may continue with the step 106 of determining whether one or more prerequisite conditions for conducting the test are met. The prerequisite conditions are intended to make sure that the test can be conducted properly and safely and produce accurate results regarding the operation of the fluid supply protection system.

One of the prerequisite conditions may be that the fluid pressure, or source pressure, in one or both of fluid sources 56, 58 meets a predetermined condition relative to a threshold source pressure (e.g., is above the threshold source pressure). In this manner, controller 56 ensures that subsequent steps in the test will not result in a reduction in the fluid pressure needed for normal operation of wheel brakes 42. Controller 56 may determine whether or not the source pressure in one or both of fluid sources 56, 58 meets the predetermined condition relative to the threshold source pressure responsive to signals received directly from pressure sensors indicative of the source pressure in fluid sources 56, 58 or indirectly from other vehicle systems that have already received signals from the pressure sensors. Controller 56 may also determine whether or not the source pressure in one or both of fluid sources 56, 58 meets the predetermined condition responsive to signals from other vehicle systems that have already made the determination.

Another prerequisite condition may be that vehicle 10 is in active state in which electrical power is being transmitted from the vehicle battery in the towing member 12 to the power unit (internal combustion engine or electric motor) of the towing member 12 as opposed to an inactive state in which electrical power is not being transmitted from the vehicle battery to the power unit. Controller 56 may determine whether vehicle 10 is in an active or inactive state responsive to signals received directly from sensors indicative of the state (e.g., current sensors indicating the flow of current from the vehicle battery or position sensors indicative of the presence or position of an ignition key or start button) or indirectly from other vehicle systems that have already received signals from the sensors. Controller 56 may also determine whether or not vehicle 10 is in active state responsive to signals from other vehicle systems that have already made the determination.

Another prerequisite condition may be that vehicle 10 is in a predetermined mobility state in which vehicle 10 is stationary or at least substantially stationary or is in motion or at least substantially in motion. Controller 56 may determine whether vehicle 10 is in a predetermined mobility state responsive to signals received directly from sensors indicative of the state (e.g., engine, transmission or wheel speed sensors indicating the speed of vehicle 10) or indirectly from other vehicle systems that have already received signals from the sensors. Controller 56 may also determine whether or not vehicle 10 is in a predetermined mobility state responsive to signals from other vehicle systems that have already made the determination.

Another prerequisite condition may be the fluid pressure, or supply conduit pressure, in supply conduit 36 meets a predetermined condition relative to a threshold supply conduit pressure (e.g., is above the threshold supply conduit pressure or below the threshold supply conduit pressure). In this manner, controller 56 can determine whether the supply conduit is charged or evacuated. Controller 56 may determine whether or not the supply conduit pressure in supply conduit 36 meets the predetermined condition relative to the threshold supply conduit pressure responsive to signals received directly from pressure sensors indicative of the supply conduit pressure in supply conduit 36 or indirectly from other vehicle systems that have already received signals from the pressure sensors. Controller 56 may also determine whether or not the supply conduit pressure in supply conduit 36 meets the predetermined condition responsive to signals from other vehicle systems that have already made the determination.

Another prerequisite condition may be the fluid pressure in fluid source 62 meets a predetermined condition relative to a threshold fluid pressure (e.g., is above the threshold fluid pressure). Controller 56 may determine whether or not the fluid pressure in fluid source 62 meets the predetermined condition relative to the threshold fluid pressure responsive to signals received directly from pressure sensors indicative of the fluid pressure in fluid source 62 or indirectly from other vehicle systems that have already received signals from the pressure sensors. Controller 56 may also determine whether or not the fluid pressure in fluid source 62 meets the predetermined condition responsive to signals from other vehicle systems that have already made the determination.

Another prerequisite condition may be the state of the parking brakes in the wheel brakes 42 on the towed vehicle 10 (i.e., that the parking brakes are applied or released). Controller 56 may determine the state of the parking brakes responsive to signals received directly from sensors indicative of the state such as pressure sensors indicative of fluid pressure opposing a spring force in the brake actuator, position sensors indicative of the position of the actuator, force sensors indicative of the applied by the spring or torque sensors indicative of torque applied to a rotational components of the wheel brake 42 or indirectly from other vehicle systems that have already received signals from these sensors. Controller 56 may also determine the state of the parking brake in towed vehicle 10 responsive to signals from other vehicle systems that have already made the determination.

Another prerequisite condition may be the that the commanded service braking force (by either the operator or an ADAS/AD system 16), meets a predetermined condition relative to a braking force threshold (e.g., is above or below the threshold). Controller 56 may determine whether the commanded service braking force meets the predetermined condition relative to the braking force threshold responsive to signals received directly from sensors indicative of the commanded service braking force such as position sensors indicating the position of a brake pedal or other operator interface element or pressure sensors indicative of the resulting service brake pressure or indirectly from other vehicle systems that have already received signals from these sensors. Controller 56 may also determine whether the commanded service braking force meets the predetermined condition relative to the braking force threshold responsive to signals from other vehicle systems that have already made the determination.

Another prerequisite condition may be the that the mass of vehicle 10 (i.e., the gross vehicle weight the towing member 12, towed members 14 and any loads carried by the towed members 14) meets a predetermined condition relative to a mass threshold (e.g., is above or below the threshold). Controller 56 may determine whether the mass of vehicle 10 meets a predetermined condition relative to a mass threshold responsive to signals received from other vehicle systems and sensors indicative of the mass of the towing member 12, the mass of towed member 14, and loads carried by the towed member 14 or indirectly from other vehicle systems that have already received signals from these systems and sensors. Controller 56 may also determine whether the mass of vehicle 10 meets a predetermined condition relative to a mass threshold responsive to signals from other vehicle systems that have already made the determination.

Another prerequisite condition may be the that the load on an axle 20, 22, or 26 meets a predetermined condition relative to a load threshold (e.g., is above or below the threshold). Controller 56 may determine whether the load on an axle 20, 22, or 26 meets a predetermined condition relative to a load threshold responsive to signals received directly from load sensors, such as load sensors 50, or indirectly from other vehicle systems that have already received signals from these sensors. Controller 56 may also determine whether the load on an axle 20, 22, or 26 meets a predetermined condition relative to a load threshold responsive to signals from other vehicle systems that have already made the determination.

Another prerequisite condition may be the presence of anti-lock braking functionality on towed member 14. Controller 56 may determine whether anti-lock braking functionality is present on towed member 14 responsive to signals received from an ABS controller on towed member 14 over bus 34 or the vehicle power line. Controller 56 may also determine whether anti-lock braking functionality is present on towed member 14 responsive to signals from other vehicle systems that have already made the determination.

Another prerequisite condition may be the presence and or status of other controllers that provide data for use in performing the test. Controller 56 may determine whether other controllers are present and/or are working in an expected manner responsive to signals received from the controllers over bus 34 or the vehicle power line. Controller 56 may also determine whether other controllers are present and/or are working in an expected manner responsive to signals from other vehicle systems that have already made the determination.

Although a number of prerequisite conditions have been described above, it should be understood that various embodiments of the method disclosed herein may include other prerequisite conditions before subsequent steps in the method are performed. In addition, the prerequisite conditions required may vary depending on the functionality of the fluid supply protection system that is being tested and whether vehicle 10 is in motion. In one embodiment, the system disclosed herein is designed to perform four different tests of the fluid supply protection system. One test (hereinafter the “Pre-Drive Protection Active Test”), determines whether the fluid supply protection system will, prior to movement of the vehicle, prevent fluid pressure from reaching control conduit 38 in situations in which a service brake control signal cannot be delivered to the towed member 14 (i.e., where a sealed fluid path from towing member 12 to towed member 14 through control conduit 38 is absent). The prerequisite conditions for the Pre-Drive Protection Active Test may include that vehicle 10 is in active state, the fluid pressure in fluid sources 56, 58 are above pressure thresholds, vehicle 10 is stationary or at least substantially stationary, and the fluid pressure in supply conduit 36 is less than a pressure threshold. Another test (hereinafter the “Pre-Drive Protection Inactive Test”) determines whether the fluid supply protection system will, prior to movement of the vehicle, allow fluid pressure to reach control conduit 38 in situations in which a service brake control signal can be delivered to the towed member 14 (i.e., where a sealed fluid path from towing member 12 to towed member 14 through control conduit 38 is present). The prerequisite conditions for the Pre-Drive Protection Inactive Test may include that vehicle 10 is in active state, the fluid pressure in fluid sources 56, 58 are above pressure thresholds, vehicle 10 is stationary or at least substantially stationary, and the fluid pressure in supply conduit 36 is above a pressure threshold. Another test (hereinafter, the “Drive Protection Active Test”) determines whether the fluid supply protection system will, after movement of the vehicle, prevent fluid pressure from reaching control conduit 38 in situations in which a service brake control signal cannot be delivered to the towed member 14 (i.e., where a sealed fluid path from towing member 12 to towed member 14 through control conduit 38 is absent). The prerequisite conditions for the Drive Protection Active Test may include that vehicle 10 is in active state, the fluid pressure in fluid sources 56, 58 are above pressure thresholds, vehicle 10 is in motion or at least substantially in motion, and the fluid pressure in supply conduit 36 is less than a pressure threshold. Yet another test (hereinafter, the “Drive Protection Inactive Test”) determines whether the fluid supply protection system will, after movement of the vehicle, allow fluid pressure to reach control conduit 38 in situations in which a service brake control signal can be delivered to the towed member 14 (i.e., where a sealed fluid path from towing member 12 to towed member 14 through control conduit 38 is present). The prerequisite conditions for the Drive Protection Inactive Test may include that vehicle 10 is in active state, the fluid pressure in fluid sources 56, 58 are above pressure thresholds, vehicle 10 is in motion or at least substantially in motion, the fluid pressure in supply conduit 36 is above a pressure threshold, and the service brakes have been applied.

If the prerequisite conditions are satisfied for the relevant test (i.e., Pre-Drive Protection Active, Pre-Drive Protection Inactive, Drive Protection Active or Drive Protection Inactive), the method may continue with the step 108 in which controller 56 configures a valve module on towing member 12 to cause delivery of fluid from fluid source 58 or 60 to control conduit 38. In the illustrated embodiment, controller 56 configures foot brake valve module 80. It should be understood, however, that the valve module configured by controller 56 is dependent on the configuration of fluid circuit 44. For example, in fluid circuits in which a separate tractor protection valve module is used between trailer pressure control valve module 100 and the supply and control conduits 36, 38, controller may alternatively configure trailer pressure control valve module 100. Performance of step 108 will vary depending on the test being performed. In tests that determine whether the fluid supply protection system will prevent fluid delivery to control conduit 38 when a sealed fluid path from towing member 12 to towed member 14 through control conduit 38 is absent (i.e., the Pre-Drive Protection Active Test and the Drive Protection Active Test), controller 56 may generate and transmit control signals to parking foot brake valve module 80 to open a bypass valve in module 80 and cause transmission of fluid to trailer pressure control valve module 100 (despite the absence of a service brake request from the operator or an ADAS/AS system 16). As discussed above, if the fluid supply protection system is active, the solenoid valves in module 100 will prevent delivery of the fluid from foot brake valve module 80 to the control port of the relay valve in module 100 and thereby prevent delivery of fluid to control conduit 38. In tests that determine whether the fluid supply protection system will allow fluid delivery to control conduit 38 when a sealed fluid path from towing member 12 to towed member 14 through control conduit 38 is present (i.e., the Pre-Drive Protection Inactive Test and the Drive Protection Inactive Test), controller 56 may configure foot brake valve module 80 as discussed above or, alternatively, may configure foot brake valve module 80 to close the bypass valve and await a service brake request from the vehicle operator or ADAS/AS system 16 which will similarly cause transmission of fluid to trailer pressure control valve module 100. If the fluid supply protection system is inactive, the solenoid valves in module 100 will allow delivery of fluid from foot brake valve module 80 to the control port of the relay valve in module 100 and thereby cause delivery of fluid to control conduit 38.

The method may continue with the step 110 of measuring the value of a characteristic (e.g., pressure or flow rate) of fluid in control conduit 38. Referring to FIG. 2, pressure or flow sensor 54 generates a measurement signal indicative of the value of a characteristic of the fluid in control conduit 38. Controller 56 may determine the value of the characteristic responsive to this measurement signal. Referring again to FIG. 4, the method may continue with the step 112 of determining, responsive to the measurement signal, whether the measured value meets a predetermined condition relative to a threshold value. Performance of step 112 will vary depending on the test being performed. In tests that determine whether the fluid supply protection system will prevent fluid delivery to control conduit 38 when a sealed fluid path from towing member 12 to towed member 14 through control conduit 38 is absent (i.e., the Pre-Drive Protection Active Test and the Drive Protection Active Test), the predetermined condition may be that the measured value is less than a threshold value. In tests that determine whether the fluid supply protection system will allow fluid delivery to control conduit 38 when a sealed fluid path from towing member 12 to towed member 14 through control conduit 38 is present (i.e., the Pre-Drive Protection Inactive Test and the Drive Protection Inactive Test), the predetermined condition may be that the measured value is greater than a threshold value. The predetermined condition may further include a time element requiring that the measured value is less than or greater than, as appropriate, the threshold value over a predetermined period of time. The threshold values and any predetermined periods of time in each test may vary. For example, the threshold values in the Pre-Drive Protection Active and Drive Protection Active tests may be lower than the threshold values in the Pre-Drive Protection Inactive and Drive Protection Inactive tests. The threshold values and any predetermined periods of time may also be configurable to allow use in different vehicles and/or the addition or substitution of components having different capabilities in the same vehicle.

If the measured value meets the predetermined condition relative to a threshold value in any of the tests, the method may end. Alternatively, the method may proceed to conduct another test. For example, at the end of the Pre-Drive Protection Active test, the method may return to step 106 of the Pre-Drive Protection Inactive Test. Similarly, at the end of the Drive Protection Active test, the method may return to step 106 of the Drive Protection Inactive Test. If the measured value does not meet the predetermined condition relative to the threshold value in any of the tests, the method may continue with the step 114 in which controller 56 generates a failure signal. The failure signal may be configured in a variety of ways to cause a variety of different actions. In some embodiments, the failure signal is configured to communicate the result of the test. For example, the failure signal may cause an operator interface in vehicle 10 to alert the vehicle operator to the failure (e.g., by actuating a light, speaker, or haptic actuator), cause a data collection system on vehicle 10 to record the failure, communicate the failure to a remote site (e.g., through a vehicle telematics system), or communicate the failure to other vehicle systems on vehicle 10. In other embodiments, the failure signal is configured to alter operation of brake control system 18 in some manner. For example, the signal may be configured for delivery to an electronic control unit of one or more valve modules 80, 82, 84, 86, 88, 98, 100 to reconfigure the valve module and limit the loss of fluid from fluid sources 58, 60 or mitigate adverse consequences of the loss of fluid from fluid sources 58, 60 including by preventing release of the parking brakes. Alternatively, the failure signal may be configured for delivery to an ADAS/AD system 16 which may, in response to the signal, perform an action to attempt to mitigate adverse consequences of the loss of fluid from fluid sources 58, 60 including by preventing movement of the vehicle if the failure occurs during the Pre-Drive Protection Active Test or Pre-Drive Protection Inactive Test. Controller 56 may be configured to generate the failure signal in response to a single failed test as shown in the illustrated embodiment. Alternatively, controller 56 may be configured to generate the failure signal only after a predetermined number of failed tests and may be configured to reset if a successful test occurs subsequent to a failed test. Controller 56 may also be configured to generate the failure signal only in cases where significant failures occur (e.g., when the measured value is less than or greater than the threshold value by more than a predetermined offset from the threshold value). Following generation of the failure signal, the method may again end or proceed to conduct another test as described above.

A system and method for testing a fluid supply protection system in a brake control system 18 of a combination vehicle 10 in accordance with the teachings disclosed herein is advantageous relative to conventional systems and methods. In particular, the system and method allow for testing multiple potential failure modes of the fluid supply protection system both before and during operation of the vehicle 10. Further, the system and method eliminate the need to rely on an assessment of the fluid supply protection system’s performance by the vehicle operator so that reliable information regarding the performance of the fluid supply protection system can be obtained in wider range of vehicles including those incorporating automated brake control functions as well as those including automated driving systems (ADS). Using this information, it is possible to predict degradation of brake performance due to (i) failure to active the fluid supply protection system when required leading to increased fluid consumption, fluid loss and a reduction in braking force and (ii) improper activation of the fluid supply protection system preventing activation of trailer service brakes.

While the invention has been shown and described with reference to one or more particular embodiments thereof, it will be understood by those of skill in the art that various changes and modifications can be made without departing from the spirit and scope of the invention.

What is claimed is:

1. A system for conducting a test of a fluid supply protection system in a brake control system in a combination vehicle, the fluid supply protection system configured to prevent delivery of fluid to a control conduit that extends between a towing member of the combination vehicle and a towed member of the combination vehicle in the absence of a sealed fluid path from the towing member to the towed member through the control conduit, the control conduit configured to transmit a service brake control signal from the towing member to the towed member, comprising:
a controller configured to
determine whether one or more prerequisite conditions are met, one of the one or more prerequisite conditions comprising a source pressure in a fluid source on the towing member above a threshold source pressure;
configure, if the one or more prerequisite conditions are met, a valve module on the towing member to deliver fluid from the fluid source to the control conduit;
determine, responsive to a measurement signal indicative of a measured value of a characteristic of fluid in the control conduit, whether the measured value meets a first predetermined condition relative to a threshold value; and,
generate a failure signal if the measured value does not meet the first predetermined condition relative to the threshold value.

2. The system of claim 1 wherein another of the one or more prerequisite conditions comprises the towing member being in an active state.

3. The system of claim 1 wherein another of the one or more prerequisite conditions comprises the towing member being in a predetermined mobility state.

4. The system of claim 1 wherein another of the one or more prerequisite conditions comprises a supply conduit pressure in a supply conduit configured to transmit a supply pressure from the towing member to the towed member meeting a second predetermined condition relative to a threshold supply conduit pressure.

5. The system of claim 1 wherein the test is conducted in response to a request transmitted by another controller on the towing member.

6. The system of claim 1 wherein the test is conducted in response to a request to apply a service brake of a wheel brake on the combination vehicle.

7. The system of claim 1 wherein the test is conducted in response to a change in a supply conduit pressure in a supply conduit configured to transmit a supply pressure from the towing member to the towed member.

8. The system of claim 1 wherein the failure signal is configured to alter operation of the brake control system of the combination vehicle.

9. An article of manufacture, comprising:
a non-transitory computer storage medium having a computer program encoded thereon that, when executed by a controller, conducts a test of a fluid supply protection system in a brake control system in a combination vehicle, the fluid supply protection system configured to prevent delivery of fluid to a control conduit that extends between a towing member of the combination vehicle and a towed member of the combination vehicle in the absence of a sealed fluid path from the towing member to the towed member through the control conduit, the control conduit configured to transmit a service brake control signal from the towing member to the towed member, the computer program including code for:
determining whether one or more prerequisite conditions are met, one of the one or more prerequisite conditions comprising a source pressure in a fluid source on the towing member above a threshold source pressure;
configuring, if the one or more prerequisite conditions are met, a valve module on the towing member to deliver fluid from the fluid source to the control conduit;
determining, responsive to a measurement signal indicative of a measured value of a characteristic of fluid in the control conduit, whether the measured value meets a first predetermined condition relative to a threshold value; and,
generating a failure signal if the measured value does not meet the first predetermined condition relative to the threshold value.

10. The article of manufacture of claim 9 wherein another of the one or more prerequisite conditions comprises the towing member being in an active state.

11. The article of manufacture of claim 9 wherein another of the one or more prerequisite conditions comprises the towing member being in a predetermined mobility state.

12. The article of manufacture of claim 9 wherein another of the one or more prerequisite conditions comprises a supply conduit pressure in a supply conduit configured to transmit a supply pressure from the towing member to the towed member meeting a second predetermined condition relative to a threshold supply conduit pressure.

13. The article of manufacture of claim 9 wherein the computer program is configured to conduct the test in response to a request transmitted by another controller on the towing member.

14. The article of manufacture of claim 9 wherein the computer program is configured to conduct the test in response to a request to apply a service brake of a wheel brake on the combination vehicle.

15. The article of manufacture of claim 9 wherein the computer program is configured to conduct the test in response to a change in a supply conduit pressure in a supply conduit configured to transmit a supply pressure from the towing member to the towed member.

16. The article of manufacture of claim 9 wherein the failure signal is configured to alter operation of the brake control system of the combination vehicle.

17. A method for conducting a test of a fluid supply protection system in a brake control system in a combination vehicle, the fluid supply protection system configured to prevent delivery of fluid to a control conduit that extends between a towing member of the combination vehicle and a towed member of the combination vehicle in the absence of a sealed fluid path from the towing member to the towed member through the control conduit, the control conduit configured to transmit a service brake control signal from the towing member to the towed member, the method comprising:
determining whether one or more prerequisite conditions are met, one of the one or more prerequisite conditions comprising a source pressure in a fluid source on the towing member above a threshold source pressure;
configuring, if the one or more prerequisite conditions are met, a valve module on the towing member to deliver fluid from the fluid source to the control conduit;
determining, responsive to a measurement signal indicative of a measured value of a characteristic of fluid in the control conduit, whether the measured value meets a first predetermined condition relative to a threshold value; and,
generating a failure signal if the measured value does not meet the first predetermined condition relative to the threshold value.

18. The method of claim 17 wherein another of the one or more prerequisite conditions comprises a supply conduit pressure in a supply conduit configured to transmit a supply pressure from the towing member to the towed member meeting a second predetermined condition relative to a threshold supply conduit pressure.

19. The method of claim 17 wherein the test is conducted in response to a change in a supply conduit pressure in a supply conduit configured to transmit a supply pressure from the towing member to the towed member.

20. The method of claim 17 wherein the failure signal is configured to alter operation of the brake control system of the combination vehicle.
